(19) United States
(12) Patent Application Publication
(10) Pub. No.: US 2026/0024356 A1
(43) Pub. Date: Jan. 22, 2026

(54) NEGATIVE EMOTION DETERMINATION DEVICE AND VEHICLE EQUIPPED WITH THE SAME

(71) Applicant: TOYOTA JIDOSHA KABUSHIKI KAISHA, Toyota-shi (JP)

(72) Inventor: Tomohiro KANEKO, Susono-shi (JP)

(73) Assignee: TOYOTA JIDOSHA KABUSHIKI KAISHA, Toyota-shi (JP)

(21) Appl. No.: 19/076,348

(22) Filed: Mar. 11, 2025

(30) Foreign Application Priority Data
Jul. 17, 2024 (JP) 2024-113783

(51) Int. Cl. G06V 20/59; G06V 10/774; G06V 40/16

(52) U.S. Cl. CPC G06V 20/59; G06V 10/774; G06V 40/174

(57) ABSTRACT

A negative emotion determination device determines whether an occupant has a negative emotion using a learned emotion estimation model for each occupant. The learned emotion estimation model is configured to output whether the occupant has the negative emotion regarding the state of a vehicle and a facial expression of the occupant by machine learning using both the state of the vehicle and a CG model as input data. The CG model is a model created based on the facial expression of the occupant captured by an in-vehicle camera.

### CROSS-REFERENCE TO RELATED APPLICATION

This application claims priority to Japanese Patent Application No. 2024-113783 filed on Jul. 17, 2024. The disclosure of the above-identified application, including the specification, drawings, and claims, is incorporated by reference herein in its entirety.

### BACKGROUND

### 1. Technical Field

The present disclosure relates to negative emotion determination devices and vehicles equipped with the same, and more particularly to a negative emotion determination device configured to determine whether an occupant has a negative emotion and a vehicle equipped with such a negative emotion determination device.

### 2. Description of Related Art

As this type of technique, a technique has been conventionally proposed in which a driver's specific driving maneuver that makes a passenger feel uncomfortable is determined from the difference between the driver's emotions and the passenger's emotions, and advice for the driver is generated based on the difference between the driver's driving characteristics and the passenger's driving characteristics regarding the specific driving maneuver (see, for example, Japanese Unexamined Patent Application Publication No. 2019-098779 (JP 2019-098779 A)). This technique attempts to implement driving that does not make a passenger feel uncomfortable.

### SUMMARY

However, it is often difficult to estimate passenger's emotions with the above technique. It is difficult to estimate passenger's emotions because emotions differ from individual to individual. It is also difficult to estimate passenger's emotions when an image of the passenger's facial expression etc. cannot be captured. It is therefore difficult to properly determine whether a passenger has a negative emotion.

A primary object of a negative emotion determination device and a vehicle equipped with the same according to the present disclosure is to more properly determine whether an occupant has a negative emotion.

In order to achieve the primary object, the negative emotion determination device and the vehicle equipped with the same according to the present disclosure adopt the following measures.

The negative emotion determination device of the present disclosure is a negative emotion determination device for a vehicle. The vehicle includes an occupant detection device configured to detect, for each occupant, presence of the occupant in the vehicle, a vehicle state detection device configured to detect a state of the vehicle, an in-vehicle camera configured to capture an image of the occupant in the vehicle, and the negative emotion determination device configured to determine whether a target occupant has a negative emotion by using either or both of the state of the vehicle and the image from the in-vehicle camera for the occupant detected by the occupant detection device. The negative emotion determination device is configured to determine whether the occupant has the negative emotion by using a learned emotion estimation model for each occupant. The learned emotion estimation model is a model configured to output whether the occupant has the negative emotion regarding either or both of the state of the vehicle and a facial expression of the occupant by machine learning using both the state of the vehicle and a computer graphics (CG) model as input data. The CG model is a model created based on the facial expression of the occupant captured by the in-vehicle camera.

The negative emotion determination device of the present disclosure determines whether the occupant has the negative emotion by using the learned emotion estimation model for each occupant. The learned emotion estimation model is configured to output whether the occupant has the negative emotion regarding either or both the state of the vehicle and the facial expression of the occupant by machine learning. The machine learning uses the state of the vehicle and the CG model created based on the facial expression of the occupant captured by the in-vehicle camera. As described above, since the negative emotion determination device determines whether an occupant has a negative emotion by using the learned emotion estimation model for each occupant, it is possible to more properly determine whether an occupant has a negative emotion. The state of the vehicle includes, in addition to data related to behaviors of the vehicle such as vehicle speed V, acceleration in the front-rear direction of the vehicle, gradient, and lateral acceleration in the left-right direction of the vehicle, data related to the environment such as weather, air temperature, in-vehicle temperature, carbon dioxide concentration in the vehicle, and presence or absence of sunlight.

The negative emotion determination device of the present disclosure may be configured to
when an image of a facial expression of the target occupant is available from the in-vehicle camera, determine whether the target occupant has the negative emotion by applying the state of the vehicle and the CG model that is based on the facial expression of the occupant to the learned emotion estimation model, and
when the image of the facial expression of the target occupant is not available from the in-vehicle camera, determine whether the target occupant has the negative emotion by applying the state of the vehicle to the learned emotion estimation model.

With this configuration, it is possible to determine whether the target occupant has a negative emotion when an image of the facial expression of the target occupant can be captured, and it is also possible to determine whether the target occupant has a negative emotion even when an image of the facial expression of the target occupant cannot be captured.

The negative emotion determination device of the present disclosure may be configured to, when the learned emotion estimation model corresponding to the target occupant is not available, create the learned emotion estimation model of the target occupant using the state of the vehicle and the CG model created based on a facial expression of the target occupant captured by the in-vehicle camera. With this configuration, it is also possible to more properly determine whether a new target occupant has a negative emotion.

The vehicle of the present disclosure is a vehicle equipped with the negative emotion determination device according to any one of the above aspects of the present disclosure.

The negative emotion determination device is configured to determine whether an unspecified occupant has the negative emotion by using an emotion estimation learning model applied to the unspecified occupant. The emotion estimation learning model is a model obtained using a plurality of the learned emotion estimation models created by the negative emotion determination device of another vehicle.

Since this vehicle of the present disclosure uses the emotion estimation learning model, it is possible to more properly determine whether an unspecified occupant has a negative emotion. The emotion estimation learning model is a model applied to the unspecified occupant and obtained using the plurality of learned emotion estimation models created by the negative emotion determination device of another vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram mainly showing a main electronic control unit 30, illustrating an example of a configuration of an automobile 20 equipped with a negative emotion determination device as an embodiment of the present disclosure; and

FIG. 2 is a flowchart illustrating an example of a negative emotion determination process executed by the main electronic control unit 30.

### DETAILED DESCRIPTION OF EMBODIMENTS

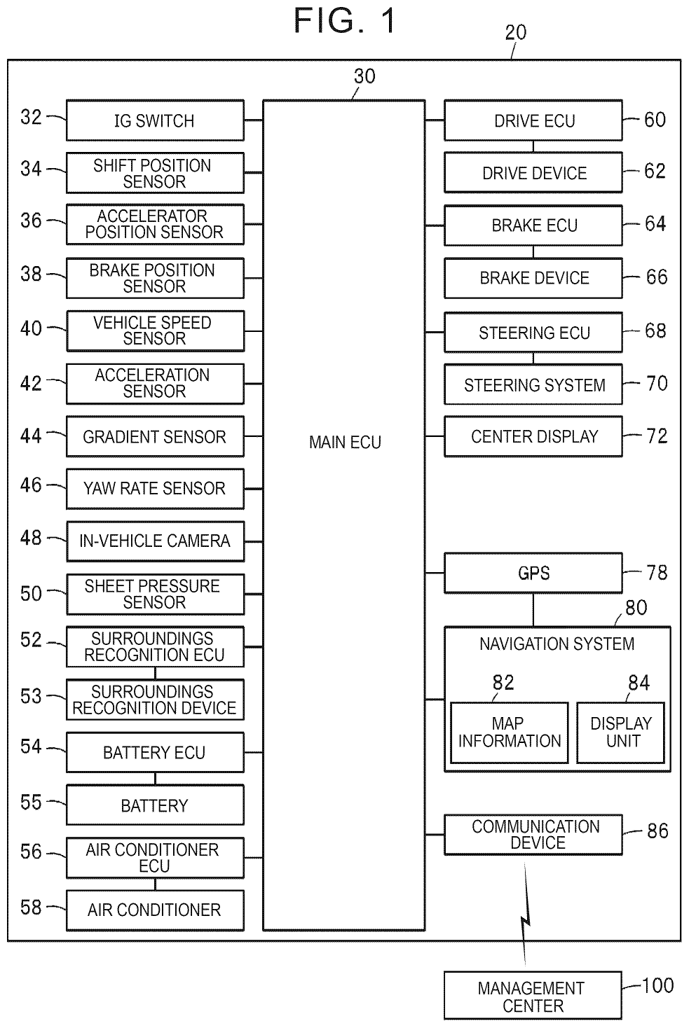

Next, a mode for carrying out the present disclosure (embodiment) will be described. FIG. 1 is a block diagram mainly showing a main electronic control unit 30, illustrating an example of a configuration of an automobile 20 equipped with a negative emotion determination device as an embodiment of the present disclosure. The negative emotion determination device of the embodiment corresponds to the main electronic control unit 30. As shown in the drawings, the automobile 20 according to the embodiment includes a drive device 62 for outputting a driving force to drive wheels (not shown), and a drive electronic control unit (hereinafter referred to as drive ECU) 60 for driving and controlling the drive device 62.

Examples of the drive device 62 include a combination of an engine and an automatic transmission, a motor, and the like. The drive ECU 60 is configured as a microcomputer centered on a CPU (not shown), and drives and controls the drive device 62 based on a drive control signal from the main ECU 30.

In addition to the drive device 62 and the drive ECU 60, the automobile 20 of the embodiment includes, an ignition switch 32, a shift position sensor 34, an accelerator position sensor 36, a brake position sensor 38, a vehicle speed sensor 40, an acceleration sensor 42, a gradient sensor 44, a yaw rate sensor 46, an in-vehicle camera 48, a seat pressure sensor 50, a surroundings recognition electronic control unit (hereinafter referred to as surroundings recognition ECU) 52, a surroundings recognition device 53, a battery electronic control unit (hereinafter referred to as battery ECU) 54, a battery 55, an air conditioner electronic control unit (hereinafter referred to as air conditioner ECU) 56, an air conditioner 58, a brake electronic control unit (hereinafter referred to as brake ECU) 64, a brake device 66, a steering electronic control unit (hereinafter referred to as steering ECU) 68, a steering system 70, a center display 72, a meter 76, a GPS (Global Positioning System, Global Positioning Satellite) 78, a navigation system 80, a communication device 86, etc.

The shift position sensor 34 detects the position of the shift lever. The accelerator position sensor 36 detects an accelerator operation amount etc. corresponding to the depression amount of the accelerator pedal of the driver. The brake position sensor 38 detects a brake position or the like as a depression amount of the brake pedal of the driver.

The vehicle speed sensor 40 detects the vehicle speed of the vehicle based on the wheel speed and the like. The acceleration sensor 42 detects acceleration in the front-rear direction of the vehicle, for example. The gradient sensor 44 detects a road surface gradient. The yaw rate sensor 46 detects lateral acceleration (yaw rate) in the left-right direction due to the turning motion. The in-vehicle camera 48 is disposed from the front to the rear of a vehicle cabin, and captures an image of the passenger in the vehicle cabin. The seat pressure sensor 50 detects whether or not an occupant is present in the seat.

The surroundings recognition ECU 52 is configured as a microprocessor centered on a CPU (not shown). In the surroundings recognition ECU 52, information on the own vehicle and its surroundings (for example, inter-vehicle distances D1, D2 between the own vehicle and other vehicles in front of and behind the own vehicle, vehicle speeds of other vehicles, a traveling position of the own vehicle in a lane on a road surface, etc.) from the surroundings recognition device 53 is input via an input port. Examples of the surroundings recognition device 54 include a front camera, a rear camera, a millimeter-wave radar, a quasi-millimeter-wave radar, an infrared laser radar, and a sonar.

The battery ECU 54 is configured as a microprocessor centered on a CPU (not shown). The battery ECU 54 receives a battery voltage Vb from a voltage sensor (not shown) attached to an output terminal of the battery 55, a battery current Ib from a current sensor, a battery temperature Tb from a temperature sensor (not shown) attached to the battery 55, and the like via an input port. The battery ECU 54 calculates the power storage ratio SOC, the input/output limit Win, Wout, and the like based on the battery voltage Vb, the battery current Ib, and the like.

The air conditioner ECU 56 is configured as a microcomputer centered on a CPU (not shown). The air conditioner ECU 56 is incorporated in an air conditioner 58 for air-conditioning the vehicle cabin, and drives and controls an air conditioner compressor or the like in the air conditioner so that the temperature of the vehicle cabin becomes a set temperature.

The brake ECU 64 is configured as a microcomputer centered on a CPU (not shown), and drives and controls a known hydraulic brake device 66. The brake device 66 is configured to perform a braking force caused by a braking force caused by depressing the brake pedal and a braking force caused by a hydraulic pressure adjustment.

The steering ECU 68 is configured as a microcomputer centered on a CPU (not shown), and drives and controls an actuator of the steering device 28 in which a steering ring (not shown) and drive wheels are mechanically connected via a steering shaft. The steering device 28 steers the drive wheels based on a steering operation of the driver, and steers the drive wheels by driving an actuator by a steering ECU 68 based on a steering control signal from the main electronic control unit 30.

The center display 72 is arranged in the center of the front of the driver's seat and the passenger's seat, and also functions as a touch panel, and executes various settings of the vehicle, applications of audio and various media, and functions as a display unit 84 of the navigation system to perform map navigation. A speaker or the like is attached to the center display 72.

GPS 78 is a device that detects the position of vehicles based on signals transmitted from a plurality of GPS satellites.

The navigation system 80 is a system that guides the host vehicle to a set destination, and includes map information 82 and a display unit 84. When the destination is set, the navigation system 80 sets a route on the basis of the destination information, the information on the current location (the current location of the host vehicle) acquired by GPS 78, and the map information 82.

The communication device 86 transmits information of the host vehicle to the management center 100 and receives various kinds of information from a management center 100.

The main electronic control unit 30 is configured as a microcomputer centered on a CPU (not shown). The main electronic control unit 30 receives, for example, an ignition switch signal from the ignition switch 32, a shift position from the shift position sensor 34, an accelerator operation amount from the accelerator position sensor 36, a brake position from the brake position sensor 38, a vehicle speed V from the vehicle speed sensor 40, an acceleration from the acceleration sensor 42, a gradient from the gradient sensor 44, a yaw rate from the yaw rate sensor 46, and the like. In addition, an image from the in-vehicle camera 48, a seat pressure Ps of the respective seats from the seat pressure sensor 50, and the like are also inputted. The main electronic control unit 30 outputs, for example, a display control signal to the center display 72, a communication control signal to the communication device 86, and the like.

The main electronic control unit 30 communicates with a surroundings recognition ECU 52, an air conditioner ECU 56, a drive ECU 60, a brake ECU 64, a steering ECU 68, and a navigation system 80, and exchanges various types of information.

The main electronic control unit 30 sets a required driving force and a required power on the basis of the accelerator operation amount from the accelerator position sensor 36 and the vehicle speed from the vehicle speed sensor 40, and transmits a drive control signal to the drive ECU 60 so that the required driving force and the required power are outputted from the drive device 62 to the vehicle.

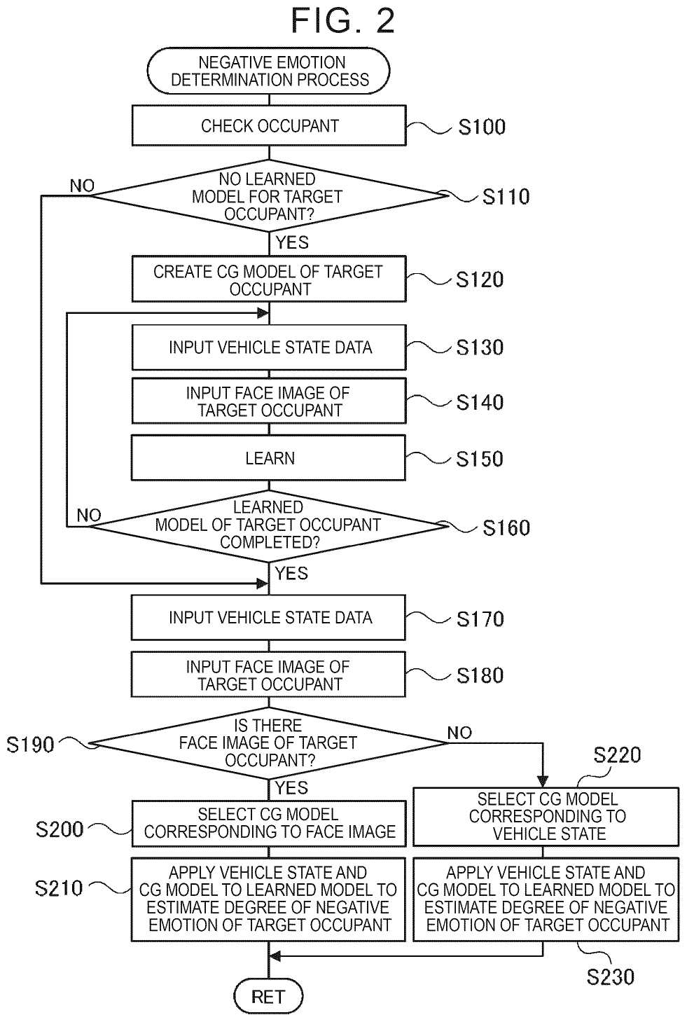

Next, the operation of the automobile 20 configured in this way, in particular, the operation when determining whether the occupant of the automobile 20 has a negative emotion will be described. The occupant includes a driver, a passenger seat, and a person occupying the rear seat. The negative emotions include those caused by motion sickness and those caused by physical abnormality. FIG. 2 is a flowchart illustrating an example of a negative emotion determination process executed by the main electronic control unit 30. This process is repeatedly executed after the system is started.

When the negative emotion determination process is executed, the main electronic control unit 30 first checks the occupant (S100). The occupant can be checked by identifying the person based on the analysis result of the image captured by the in-vehicle camera 48. In addition, if only the presence or absence of the occupant is determined, it is also possible to determine on which seat the occupant is located based on the detection value from the seat pressure sensor 50.

Next, it is determined whether a learned emotion estimation model is stored for each occupant (S110). For those whose learned emotion estimation model is not stored, a learned emotion estimation model based on a CG model is created and stored by the processes of S120 to S140.

In the creation of the learned emotion estimation model, a CG model (computer graphics model) for the face of the target occupant is created from the image of the target occupant captured by the in-vehicle camera 48 (S120). Then, the vehicle state data is input (S130), the face image of the target occupant is input (S140), and the degree of the negative emotion of the target occupant is learned based on the vehicle state data, a CG model corresponding to the face image of the target occupant, and the negative emotion of the target occupant (S150). The learning includes creation of a learned model for selecting a CG model corresponding to the facial images of the target occupant with respect to the vehicle state data. Examples of the vehicle state data include the vehicle speed V detected by the vehicle speed sensor 40, the acceleration α in the front-rear direction of the vehicle detected by the acceleration sensor 42, the gradient θ detected by the gradient sensor 44, the lateral acceleration (yaw rate) in the left-right direction of the vehicle detected by the yaw rate sensor 46, the weather, the air temperature, the in-vehicle temperature, the carbon dioxide concentration in the vehicle, the presence or absence of solar radiation, and the time. As the learning, machine learning such as deep learning can be used. Such learning is repeated until the learned emotion estimation model based on the CG model is completed (S160).

When the creation of the learned emotion estimation model by the CG model of the target occupant is completed, the vehicle state data is input and the face image of the target occupant is input (S180), and it is determined whether or not the face image of the target occupant has been input (S190). The face image of the target occupant may not be input when the target occupant is turned down, and thus the face image of the target occupant is determined.

When it is determined that the face image of the target occupant can be input by S190, a CG model corresponding to the input face image is selected (S200), and the vehicle state data and the selected CG model are applied to the learned emotion estimation model to estimate the degree of the negative emotion of the target occupant (S210), and the process ends. This makes it possible to more properly estimate the degree of the negative emotion of the target occupant.

On the other hand, when it is determined in S190 that the facial images of the target occupant cannot be input, a CG model corresponding to the input vehicle state data is selected (S220), and the vehicle state data and the selected CG model are applied to the learned emotion estimation model to estimate the degree of the negative emotion of the target occupant (S230), and the process ends. This makes it possible to more properly estimate the degree of the negative emotion of the target occupant even when the face image of the target occupant cannot be input.

In the negative emotion determination device mounted on the automobile 20 according to the embodiment described above, the degree of the negative emotion of the target occupant is estimated by applying the vehicle state data and CG model selected based on the facial images of the target occupant captured by the in-vehicle camera 48 to the learned emotion estimation model. Accordingly, it is possible to more properly determine whether the occupant has a negative emotion. In addition, when the face image of the target occupant is input, a CG model corresponding to the input face image is selected, and the vehicle state data and the selected CG model are applied to the learned emotion estimation model to estimate the degree of the negative emotion of the target occupant. This makes it possible to more properly estimate the degree of the negative emotion of the target occupant. Further, when the facial images of the target occupant cannot be input, a CG model corresponding to the input vehicle state data is selected, and the vehicle state data and the selected CG model are applied to the learned emotion estimation model to estimate the degree of the negative emotion of the target occupant. This makes it possible to more properly estimate the degree of negative emotion of the target occupant even when the face image of the target occupant cannot be input.

In the negative emotion determination device mounted on the automobile 20 according to the embodiment, a CG model of the target occupant and the learned emotion estimation model are created by the main electronic control unit 30 mounted on the automobile 20. The CG model and learned emotion estimation model of the target occupant may be created by the management center 100, the cloud server, or the like.

In the negative emotion determination device mounted on the automobile 20 of the embodiment, the learned emotion estimation model created by the main electronic control unit 30 mounted on the automobile 20 is used, but the learned emotion estimation model created by another vehicle or the like may be acquired and used. In this case, as the learned emotion estimation model, it is preferable to use a learned model for each of the age categories such as a child, an adult, and an elderly person according to the degree of easy occurrence of a negative emotion such as a person who is susceptible to motion sickness or a person who is difficult to motion sickness.

The correspondence between the main elements of the embodiments and the main elements of the disclosure described in the column of the means for solving the problem will be described. In the embodiment, the in-vehicle camera 48 and the seat pressure sensor 50 correspond to the “occupant detection device”, the vehicle speed sensor 40, the acceleration sensor 42, the gradient sensor 44, the yaw rate sensor 46, and the like correspond to the “vehicle state detection device”, the in-vehicle camera 48 corresponds to the “in-vehicle camera”, and the main electronic control unit 30 corresponds to the “negative emotion determination device”.

Note that the correspondence between the main elements of the embodiment and the main elements of the disclosure described in the section of the means for solving the problem is an example for specifically explaining the embodiment of the disclosure described in the section of the means for solving the problem, and therefore the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Although the present disclosure has been described with reference to the embodiments, it is needless to say that the present disclosure is not limited to such embodiments, and can be implemented in various forms without departing from the gist of the present disclosure.

The present disclosure is applicable to a manufacturing industry of an in-vehicle negative emotion determination device.

What is claimed is:

1. A negative emotion determination device for a vehicle, the vehicle including
an occupant detection device configured to detect, for each occupant, presence of the occupant in the vehicle,
a vehicle state detection device configured to detect a state of the vehicle,
an in-vehicle camera configured to capture an image of the occupant in the vehicle, and
the negative emotion determination device configured to determine whether a target occupant has a negative emotion by using either or both of the state of the vehicle and the image from the in-vehicle camera for the occupant detected by the occupant detection device,
wherein the negative emotion determination device is configured to determine whether the occupant has the negative emotion by using a learned emotion estimation model for each occupant, the learned emotion estimation model being a model configured to output whether the occupant has the negative emotion regarding either or both of the state of the vehicle and a facial expression of the occupant by machine learning using both the state of the vehicle and a computer graphics model as input data, the computer graphics model being a model created based on the facial expression of the occupant captured by the in-vehicle camera.

2. The negative emotion determination device according to claim 1, wherein the negative emotion determination device is configured to
when an image of a facial expression of the target occupant is available from the in-vehicle camera, determine whether the target occupant has the negative emotion by applying the state of the vehicle and the computer graphics model that is based on the facial expression of the occupant to the learned emotion estimation model, and
when the image of the facial expression of the target occupant is not available from the in-vehicle camera, determine whether the target occupant has the negative emotion by applying the state of the vehicle to the learned emotion estimation model.

3. The negative emotion determination device according to claim 1, wherein the negative emotion determination device is configured to, when the learned emotion estimation model corresponding to the target occupant is not available, create the learned emotion estimation model of the target occupant using the state of the vehicle and the computer graphics model created based on a facial expression of the target occupant captured by the in-vehicle camera.

4. A vehicle equipped with the negative emotion determination device according to claim 1, wherein the negative emotion determination device is configured to determine whether an unspecified occupant has the negative emotion by using an emotion estimation learning model applied to the unspecified occupant, the emotion estimation learning model being a model obtained using a plurality of the learned emotion estimation models created by the negative emotion determination device of another vehicle.
